(19) United States
(12) Patent Application Publication
(10) Pub. No.: US 2009/0090822 A1
(43) Pub. Date: Apr. 9, 2009

(54) Mounting device

(76) Inventor: Teruo Maeda, Yokohama-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/905,920

(22) Filed: Oct. 5, 2007

(51) Int. Cl. F16M 11/18; B63B 17/00; B64C 1/00

(52) U.S. Cl. 248/179.1; 114/343; 244/118.5; 244/118.1

(57) ABSTRACT

A mounting device including a base, a movable body, a supporting mechanism disposed therebetween, and a controller for controlling the mechanism. The mechanism applies supporting force to the movable body from a plurality of positions of the base to support the movable body on the base and determines a center of oscillation of the movable body with respect to the center of oscillation which is higher than the center of gravity of the movable body. The controller controls the mechanism to shift the center of oscillation, by changing directions support forces, at least in a horizontal direction according to a change of the center of the oscillation so that a change in an inclination of the mounting device due to a load transfer to the movable body can be decreased.

### BACKGROUND OF THE INVENTION

1. Field of the Invention

The present invention relates to a mounting device including a base and a movable body for mounting a passenger, a cargo or the like thereon, the base supporting the movable body so that a change in an inclination of the movable body due to a load shift thereof can be decreased.

2. Description of the Related Art

In some mounting devices such as water vehicles, efforts have been made to provide ride comfort and/or carrying stability of cargoes by keeping floors in a horizontal direction. Such conventional ships are disclosed in Japanese patents laid-open publication No. (Hei) 6-286687 and No. (Hei) 6-166396. These conventional ships are equipped with a plurality of fins which are provided at a right side and a left side of a hull thereof. The fins are independently controlled to change their angles of attack so as to suppress a rolling motion, a pitching motion and the like of the hull. They are, however, unavailable at a low relative speed of water and at a stop thereof. In addition, applications of the fins are limited to the vehicles moving in or on fluid, for example, the ships and the airplanes.

Other conventional mounting devices without using the fins are disclosed in Japanese patents laid-open publication No. (Hei) 10-81294, No. 2000-38194 and No. (Hei) 4-281955.

JP No. (Hei) 10-81294 discloses a ship including a hull with a concave surface at its upper portion and a cabin having a shape like a hemisphere or a half circular cylinder at its side wall portions. The cabin is capable of swinging relative to the hull by sliding its side wall portions along the concave surface of the hull due to the gravity acting on the cabin so that the rolling motion and/or pitching motion of the cabin can be suppressed in spite of the similar motion(s) of the hull. JP No. 2000-38194 discloses a seat device, which is used four the ships and includes a seat with a base plate having a convex surface at its bottom portion, a base block provided at a hull side and formed at its top portion with a concave surface facing the convex surface, a plurality of roll isolators disposed between the convex surface and the concave surface, and a damper disposed between the base plate and the base block. The convex surface and the concave surface are formed to have a part of an outer surface of a circular cylinder, so that a pitching motion of the seat can be suppressed in spite of a pitching motion of the ship. The damper is electrically controlled to change its damping characteristics to decrease the pitching motion of the seat. JP No. (Hei)4-281955 discloses a floor structure including a base with a concave surface at its top portion, a swingable floor provided at it bottom portion with a convex surface facing the concave surface, and a plurality rotating members disposed between the concave surface and the convex surface. The convex and concave surfaces are formed to have a part of an outer surface of a circular cylinder, so that a swinging motion of the floor can be suppressed in spite of a swinging motion of the base.

These conventional ships, seat device and floor structure described above, however, encounter a problem in that the cabin, seat and floor thereof are kept inclined in undesired attitudes when the centers of gravity thereof change from its proper position due to changes of load distribution of passengers and cargoes, namely due to a load shift thereof.

It is, therefore, an object of the present invention to provide a mounting device which overcomes the foregoing drawbacks and can be applied to a device that can be used with and without fluid and suppress a change in an inclination of a movable body, for mounting a passenger or a cargo, when the center of gravity of the movable body is changed due to a change in load distribution of the movable body and also when a base supporting the movable body swings.

### SUMMARY OF THE INVENTION

According to a first aspect of the present invention there is provided a mounting device including a base, a movable body for mounting at least one of a passenger and a cargo, a supporting mechanism disposed between the base and the movable body, and a controller for controlling the supporting mechanism. The supporting mechanism is capable of applying supporting forces to the movable body from a plurality of positions of the base to support the movable body on the base and determining a center of oscillation of the movable body so that the movable body can swing relative to the base due to gravity acting on the movable body with respect to the center of oscillation which is set higher than the center of gravity of the movable body. The controller is capable of shifting the center of oscillation, by changing directions support forces acting on the movable body, at least in a horizontal direction according to a change of the center of the oscillation so that the a change in an inclination of the movable body due to a load transfer to the movable body can be decreased.

### BRIEF DESCRIPTION OF THE DRAWINGS

The objects, features and advantages of the present invention will become apparent as the description proceeds when taken in conjunction with the accompanying drawings, in which:

FIG. 1 is a plan view showing a mounting device of a first embodiment according to the present invention, applied to a water vehicle including a hull, a cabin and a supporting mechanism disposed between the hull and the cabin for suppressing an inclination of the cabin in a plane of a rolling motion of the cabin;

FIG. 2 is a front view showing a relationship between the center of gravity and a center of oscillation of the cabin in a state where the center of gravity of the cabin is at a center of the cabin in the front view;

FIG. 3 is an enlarged side view showing a pair of wheel and receiver assembly of the supporting mechanism;

FIG. 4 is an enlarged front view showing another pair of the assembly used in the supporting mechanism shown in FIG. 1;

FIG. 5 is an enlarged front view showing a damper with a stopper connecting the hull and the cabin with each other, where the damper is arranged at a center position of the cabin as shown in FIG. 1;

FIG. 6 is a front view showing a relationship between the centers of gravity and the centers of oscillation before and after a load transfer to the cabin in a state where the center of gravity of the cabin changes its position in a lateral direction of the cabin, due to the load transfer from a position shown in FIG. 2 and accordingly inclinations of the receivers are controlled to be changed to shift the center of oscillation of the cabin for keeping the cabin in a horizontal direction;

FIG. 7 is a perspective view showing a mounting device of a second embodiment according to the invention, for suppressing inclinations of a cabin in planes of a rolling motion and a pitching motion thereof;

FIG. 8 is a perspective view showing an upper part of a mounting device of a third embodiment according to the invention, for suppressing inclinations of a cabin in planes of a rolling motion and a pitching motion thereof;

FIG. 9 is a perspective view showing a pair of wheel and receiver assembly of a mounting device of a fourth embodiment according to the invention, for suppressing inclinations of a cabin by using three pairs of the assemblies in planes of a rolling motion and a pitching motion thereof;

FIG. 10 is a schematic perspective view showing an arrangement of the three pairs of the assemblies, one of which is shown in FIG. 9, where the cabin can swing around a center of oscillation of the cabin;

FIG. 11 is a perspective view showing a pair of ball and receiver assembly of the mounting device of the fifth embodiment where three pairs of the assemblies are arranged similarly to that of the fourth embodiment shown in FIG. 10, for suppressing inclinations of a cabin by using three pairs of the assemblies in planes of a rolling motion and a pitching motion thereof;

FIG. 12 is a perspective view showing a pair of bag and receiver assembly of a mounting device of a sixth embodiment according to the invention, for suppressing inclinations of a cabin by using three pairs of the assemblies in any swinging motion direction; and

FIG. 13 is a schematic diagram showing a change of supporting states of the ball and receiver assembly shown in FIG. 12 of the mounting device of the sixth embodiment when inclinations of the receivers are changed.

### DETAILED DESCRIPTION OF THE PREFERRED EMBODIMENTS

Throughout the following detailed description, similar reference characters and numbers refer to similar elements in all figures of the drawings, and their descriptions are omitted for eliminating duplication.

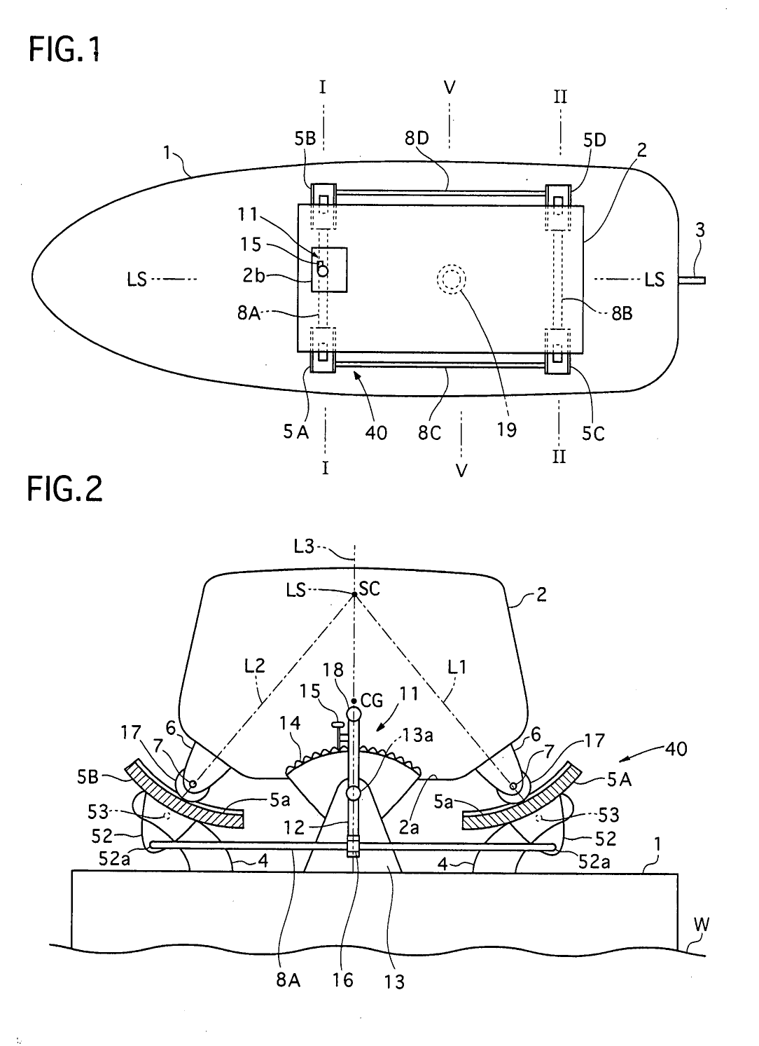

Referring to FIGS. 1 and 2 of the drawings, there is shown a first preferred embodiment of a mounting device according to the present invention. In the first embodiment, the mounting device is applied to a water vehicle such as a boat and a ship for keeping a floor for a passenger and/or a cargo to be substantially horizontal in a plane of a rolling motion thereof.

The water vehicle includes a hull 1, a cabin 2, and a supporting mechanism 40 disposed between the hull 1 and the cabin 2. The hull 1 corresponds to a base of the present invention, and the cabin 2 corresponds to a movable body of the present invention.

The hull 1 is equipped with a rudder 3 at its rear portion, and mechanically and supports the cabin 2 at its intermediate portion by the supporting mechanism 40. The supporting mechanism 40 keeps the cabin 2 as possible in this embodiment in a state where the hull 1 and the cabin 2 are swingable relative to each other.

The cabin 2 is provided with a flat floor 2a therein for mounting a passenger and/or a cargo thereon. The floor is not limited to be flat, and may be formed appropriately according to need.

As shown in FIGS. 1 and 2, the supporting mechanism 40 includes four pairs of wheel and receiver assemblies; wheels 17 and their four receivers 5A to 5D at four corner portions of the cabin 2, respectively. Each of the wheels 17 corresponds to a rotating member of the invention, and each of the receivers 5A to 5D corresponds to a guide member of the invention.

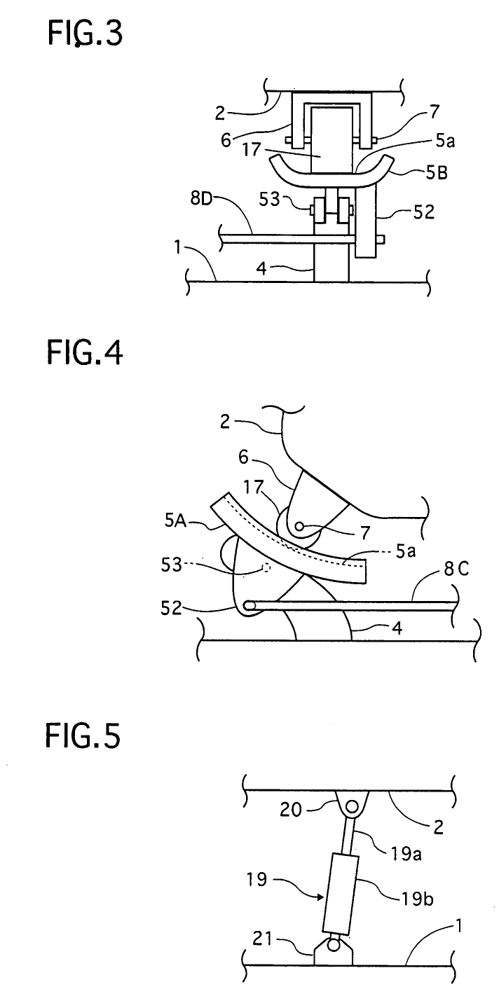

The wheels 17 are rotatably supported through shafts 7 by brackets 6 attached to the four corner portions of the cabin 2, respectively, as shown in FIGS. 2 to 4.

The first to fourth receivers 5A to 5D are formed to each have a concave surface 5a along which the wheel 17 can roll. The concave surface 5a corresponds to a guide surface of the invention.

The concave surfaces 5a of the first and second receivers 5A and 5B are arranged at a front side of the hull 1, being aligned in a lateral direction of the hull 1. The concave surfaces 5a of the third and fourth receivers 5C and 5D are arranged at a rear side of the hull 1, being aligned in the lateral direction. The first to fourth receivers 5A to 5D have side wall portions at both sides of the concave surfaces 5a to prevent the wheels 17 from dropping off from the concave surfaces 5a.

Each of the receivers 5A to 5D is provided with an arm portion 52, which is rotatably supported at its intermediate portion by a hull-side bracket 4 through a shaft 53 so that the concave surface 5a can be inclined relative to the hull 1. The first receiver 5A and the second receiver 5B are mechanically connected with each other at lower portions of their arm portions 52 by a first rod 8A extending in the lateral direction so that an inclination change of one of the first and second receivers 5A and 5B can cause an inclination change of the other thereof through the first rod 8A. The third receiver 5C and the fourth receiver 5D are mechanically connected with each other at lower portions of their arm portions 52 by a second rod 8B extending in the lateral direction so that an inclination change of one of the third and fourth receivers 5C and 5D can cause an inclination change of the other thereof through the second rod 8B. Similarly, the first receiver 5A and the third receiver 5C are mechanically connected with each other at the lower portions of their arm portions 52 by a third rod 8C extending in a longitudinal direction of the hull 1, and the second receiver 5B and the fourth receiver 5D are mechanically connected with each other at the lower portions of their arm portions 52 by a fourth rod 8D extending in the longitudinal direction.

Accordingly, operating torque, applied by the lever 18 for changing the inclinations of the first and second receivers 5A and 5B, is transmitted to the third and fourth receivers 5C and 5D through the third and fourth rods 8C and 8D and then through the second rod 8B, so that the first to fourth receivers 5A to 5D can be rotated in the same rotation direction. Note that the first to fourth rods 8A to 8D act as a part of the supporting mechanism 40, although the second rod 8B is not indispensable to the invention. In addition, the rods 8A to 8D may be replaced with other torque/force transmitter such as cables and pulleys.

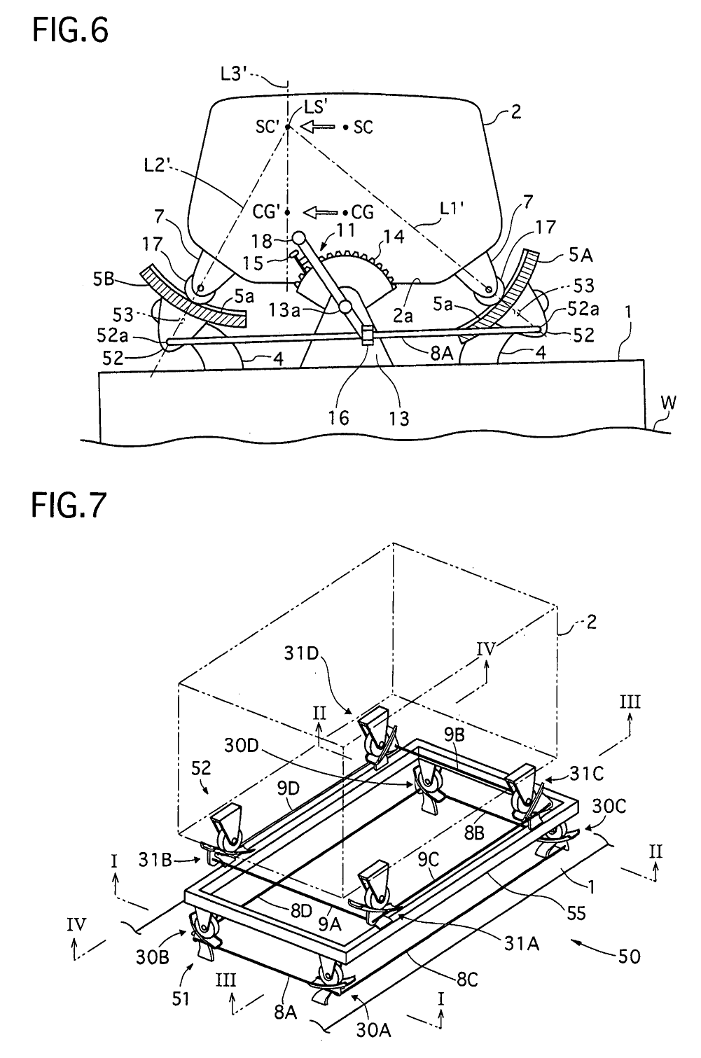

The configurations of the concave surfaces 5a are designed to determine a center of oscillation SC (SC′) of the cabin 2, as shown as FIGS. 2 and 6, so that the center SC (SC′ in FIG. 6) can be shifted to be substantially on a vertical line L3 (L3′ in FIG. 6) substantially passing through the center of gravity CG (CG′), being kept higher than the center of gravity CG (CG′) in spite of inclination angle changes of the first to fourth receivers 5A to 5D. Their details will be later explained in a description of an operation of the first embodiment.

As shown in FIGS. 1 and 2, the controller 11 includes an operating lever 18, a detent plate 14 and a detent pin 15.

The operating lever 18 is pivoted at its intermediate portion around a shaft 13a of a supporting bracket 13 attached to the hull 1, and is connected at its bottom portion with the first rod 8A. The lever 18 and the first rod 8a is connected by using a connector 16 provided with the bottom portion of the lever 18 in such a manner that the connector 16 allows them to move in a vertical direction relative to each other so as to absorb a misalignment therebetween by using a not-shown elastic member for example when the lever 18 is operated, while the connector 16 moves them together in a horizontal direction to transmit the torque of the lever 18.

The operating lever 18 holds the detent pin 15, which is biased by a not-shown spring toward the detent plate 14 fixed to the supporting bracket 13. When the detent pin 15 is operated upward, it became free from grooves formed on a top portion of the detent plate 14, so that the lever 18 becomes free to move. When the detent pin 15 is pressed in one of the grooves of the detent plate 14 by the spring after an operation of the lever 18, the lever 18 is locked at its operated position, being maintained at a lock position thereof.

A power assist unit, using an electric motor for example, may be added to apply assist force to the operating lever 18 with intent to decrease its operating force of a user for an easy operation. Alternatively, the connector 16 may be replaced by a rack-and-pinion, where the rack is connected with the first rod 8A and the pinion is rotated by an electric motor according to an operating position of the lever 18 or an operating button. Note that the rack-and-pinion itself has a locking function.

Referring to FIGS. 1 and 5, the cabin 2 is mechanically connected with the hull 1 by a damper 19 with a stopper at a center position of the cabin 2. Specifically, the damper 19 includes a rod 19a with a not-shown piston and a cylinder 19b containing the piston, where orifices provided with the piston generate damping force when they move relative to each other. The rod 19a is rotatably supported by a bracket 20 attached to the cabin 2, and the cylinder 19b is rotatably supported by a bracket 21 attached to the hull 1. The rod 19a and the cylinder 19b are set rotatable on an intermediate vertical plane V-V in FIG. 1 extending in the lateral direction of the hull 1. The stopper, not shown, is configured to be capable of restricting a maximum stroke thereof so that the wheels 17 can be prevented from being dropped off from the concave surfaces 5a. Damping characteristics of the damper 19 are determined to be appropriate for better ride comfort during a swinging motion of the cabin 2.

Incidentally, as shown in FIG. 1, the cabin 2 is formed with an opening 2b through which the operating lever 18 is projected in the cabin 2, where the dimensions of the opening 2b are set so that the lever 18 and the detent plate 14 can be prevented from interfering with a wall portion surrounding the opening 2b when the lever 18 is operated and the cabin 2 swings around the center of the oscillation CS (CS′). The opening 2b is blocked with a not-shown cover. The opening 2b and the cover can be removed when the controller 11 may be installed out of the cabin 2.

The operation of the mounting device of the first embodiment will be described with reference to the accompanying drawings of FIGS. 2 and 6.

FIG. 2 shows a state where the flat floor 2a is kept horizontal and a state where load acts on the center, in the front view, in the lateral direction of the cabin 2. This state is a proper one in the embodiment. In these cases, the inclinations of the receivers 5A to 5D are controlled by the controller 11 so that the center of oscillation SG is set higher than the center of gravity OG, being on a front vertical line L3 substantially in a front vertical plane I-I in FIG. 1. The front vertical plane I-I, as shown in FIG. 1, is vertical to the hull 1 and includes the contact points, of the wheels 17 and the concave surfaces 5a of the first and second receivers 5A and 5B, thereon. The vertical line L3 passes through the center of the cabin 2 in the front vertical plane I-I.

Similarly, a not shown center of oscillation of the cabin 2 is set higher than the center of gravity OG, being substantially in a rear vertical plane II-II shown in FIG. 1. The rear vertical plane II-II is vertical to the hull 1 and includes the contact points, of the wheels 17 and the concave surfaces 5a of the third and fourth receivers 5C and 5D, thereon. A rear vertical line passes through the center of the cabin 2 in the rear vertical plane II-II.

Specifically, in these cases, the operating lever 18 is located at a midst-positioned groove of the detent plate 14, and the first and second receivers 5A and 5B are inclined to have the same angles, being axisymmetric with respect to each other. In addition, a first perpendicular line L1 and a second perpendicular line L2 intersect substantially on the front vertical plane I-I to determine the center of oscillation SC of the cabin 2 at their intersection point, where the lines L1 and L2 are determined based on the inclination angles of the first and second receivers 5A and 5B as follows. The first perpendicular line L1 is determined so that it is perpendicular to the concave surface 5a of the first receiver 5A at the first contact point thereof, and the second perpendicular line L2 is determined is determined so that it is perpendicular to the concave surface 5a of the second receiver 5B at the second contact point thereof. In this embodiment, the first and second lines L1 and L2 are substantially on the front vertical plane I-I.

The center of oscillation SC in the front vertical plane I-I is set to be substantially on the vertical line L3 and be higher than the center of gravity CG of the cabin 2, where the height of the center of oscillation SC is determined appropriately, allowing for better ride comfort.

On the other hand, although the center of oscillation of the cabin 2 in the rear vertical plane II-II is not illustrated in FIG. 2, it is determined to be higher than the center of gravity CG by adjusting inclination angles of the third and fourth receivers 5C and 5D, similarly to the center of oscillation Sc substantially on the front vertical plane I-I. The rear vertical plane II-II includes third and fourth contact points of the wheels 17 and the concave surfaces 5a of the third and fourth receivers 5C and 5D. In FIG. 2, the center of oscillation substantially in the rear vertical plane II-II is at the position same as the center of the oscillation SC on the front vertical plane I-I. That is, they are substantially overlapped in FIG. 2.

Therefore, the hull 1 and the cabin 2 can swing relative to each other in a rolling-motion direction around a swing center line LS connecting the centers of oscillation substantially in the front and rear vertical planes I-I and II-II as long as a load transfer to the cabin 2 does not occur. This relationship keeps the flat floor 2a of the cabin 2 horizontal due to the gravity acting on the cabin 2 in spite of a rolling motion of the hull 1. Incidentally, the swing center line LS extends frontward and rearward of the cabin 2 in FIG. 2, in perpendicular to the front and rear vertical planes I-I and II-II, passing through the center of the oscillation SC.

On the other hand, a load transfer caused by a passenger and/or a cargo changes the center of gravity CG shown in FIG. 2 to a new center of gravity CG shown in FIG. 6, which is located at a position apart from the center point of the cabin 2 in a left direction (a direction from the first receiver 5A toward the second receiver 5B) in FIG. 6. This load transfer to the cabin 2, namely a change of load distribution, causes the flat floor 2a of the cabin 2 to be inclined to impair the proper state of the cabin 2 shown in FIG. 2 in case where the center of oscillation SC is maintained, because the gravity acting on the cabin 2 turns the cabin 2 so that the new center of gravity CG becomes to be directly blow the center of oscillation SC.

In order to avoid such an inclination of the cabin 2, a user releases an engagement between the detent pin 15 and the detent plate 14 by pulling up the detent pin 15, and then turns the operating lever 18 around the shaft 13a to move the first rod 8 in a right direction in FIGS. 2 and 6.

This operation of the lever 18 moves the first rod 8A in the right direction (a direction from the second receiver 5B toward the first receiver 5A) in FIG. 6, which changes the inclination angles of the first and second receivers 5A and 5B so that the inclination angle of the first receiver 5A increases and the inclination angle of the second receiver 5B reduces.

In addition, this movement of the first rod 8A is transmitted to the third and fourth receivers 5C and 5D through the third and fourth rods 8C and 8D and the second rod 8B to change their inclination angles similarly to those of the first and second receivers 5A and 5B.

Consequently, the wheels 17 move along the concave surfaces 5a of the receivers 5A to 5D due to the gravity acting on the cabin 2 and consequently their contact points change.

The changes in the contact-points cause the first and second perpendicular lines to move in the left direction from the initial positions illustrated by the lines L1 and L2 in FIG. 2 to new positions illustrated by lines L1′ and L2′ in FIG. 6.

Specifically, the inclination of the first perpendicular line L1′ decreases and that of the second perpendicular line L2′ increases. This causes their intersection point, as a new center of oscillation SC′ of the cabin 2, to shift in the left direction, in FIG. 6, substantially in the front vertical plane I-I. The new center of oscillation SC′ is located substantially on the new vertical line LC3′ passing through the changed center of gravity CG′ at a position higher than the new center of the gravity CS′ in the front vertical plane I-I, because the concave surfaces 5a of the first and second receivers 5A and 5B are formed to exert the supporting forces acting on the wheels 17 of the cabin 2 in a direction perpendicular to the concave surfaces 5a at their contact points, respectively.

The center of oscillation in the rear vertical plane is shifted similarly to the center of the oscillation SC (SC′) substantially in the front vertical plane, and they are substantially overlapped with each other backward and forward in FIG. 6. Therefore, the cabin 2 is kept horizontal, and the hull 1 and the cabin 2 can be swung relative to each other around a new swing center line LS′ connecting the new center of oscillation SC′ substantially in the front vertical plane I-I and the new center of oscillation substantially in the rear vertical plane II-II. This swingable motion between the cabin 2 and the hull 1 can suppress the inclination of the cabin 2 to be horizontal in a front view, in spite of the rolling motion of the hull 1, as long as the load distribution in the cabin 2 is not changed.

Incidentally, the heights of the new centers of oscillation may be varied when the new centers are shifted in the lateral direction as long as they are higher than the new center of gravity CG′. The heights are determined by the configurations of the concave surfaces 5a and others, and accordingly an optimum period of oscillation of the cabin 2 can be obtained by adjusting the heights, allowing for better ride comfort, since the lengths of oscillating arms are determined by the heights.

As described above, the mounting device of the first embodiment can keep the flat floor 2a of the cabin 2 substantially horizontal, thereby providing better ride comfort, when the load transfer to the cabin 2 occurs in the lateral direction and also when the hull 1 oscillates in the rolling motion direction in a state of the load transfer.

Note that, actually, the first lines L1 and L1′ and the second lines L2 and L2′ are not necessary for being located precisely on the first and second vertical planes I-I and II-II, respectively, because of fluctuation of parts of the assemblies and others, but most of all because of no necessity for preciseness in order to keep the cabin 2 substantially horizontal. Therefore, the lines may not intersect with each other in actual, but they are set to intersect with each other near the center of the oscillation on the front and rear vertical planes I-I and II-II, when they are seen as projected ones on the vertical planes I-I and II-II in the front views of FIGS. 2 and 6. In this state, hull 1 and the cabin 2 can move relative to each other to provide the above-described advantages.

In addition, when the concave surfaces 5a and the wheels 17 are aligned in a longitudinal direction of the hull 1 instead of the lateral direction as described above, the mounting device can keep the cabin 2 substantially horizontal in spite of a pitching motion of the hull 1.

Next, a mounting device of a second embodiment according to the invention will be described with reference to the accompanying drawing.

Referring to FIG. 7, there is shown the second preferred embodiment of the mounting device, which is also applied to a water vehicle. In the second embodiment, a hull 1 and a cabin 2 are swingable relative to each other in both of a rolling motion direction and a pitching motion direction.

The mounting device includes the hull 1, the cabin 2 with a flat floor therein, and a supporting mechanism 50 disposed between the hull 1 and the cabin 2.

The hull 1 and the cabin 2 are constructed similarly to those of the first embodiment, although the hull 1 is partially illustrated and the cabin 2 is more schematically illustrated by alternate long and two short dashes lines in FIG. 7.

The supporting mechanism 50 has a rectangular frame 55, a first supporting mechanism 51 disposed between the hull 1 and the rectangular frame 55, and a second supporting mechanism 52 disposed between the rectangular frame 55 and the cabin 2. The rectangular frame 55 corresponds to an intermediate supporting member of the invention.

The first supporting mechanism 51 is constructed similarly to the supporting mechanism 40 of the first embodiment except four upper brackets for supporting wheels being attached to four corner portions of the rectangular frame 55 in the second embodiment instead of the brackets 6 being attached to the cabin 2 in the first embodiment. The first supporting mechanism 51 has first to fourth pairs of wheel and receiver assemblies 30A to 30D. The receivers are each provided with a concave surface along which the wheel can roll, where the concave surfaces guide the wheels in a lateral direction of the hull 1 to enable the cabin 2 to swing in a rolling motion direction as well as those of the first embodiment.

The receivers of the pairs of the assemblies 30A to 30B are connected with first to fourth rods 8A to 8D, and the first rod 8A is movable in the lateral direction by a not-shown controller similarly to those of the first embodiment.

The first supporting mechanism 51 is used for shifting a first swing center line in the lateral direction when a load transfer to the cabin 2 occurs in the lateral direction, where a first swing center line connects the centers of oscillation of the cabin 2 in front and rear vertical planes I-I and II-II. This shift of the first swing center line is controlled to keep the cabin 2 substantially horizontal through the rectangular frame 55, when they are seen in a front view of FIG. 7, by suppressing an inclination change of the cabin 2 in spite of a rolling motion of the hull 1 in the front view. The front center of oscillation is determined by using the first and second receivers 30A and 30B and their wheels rotatable thereon, and the rear center of oscillation is determined by using the third and fourth receivers 30C and 30D and their wheels rotatable thereon.

The second supporting mechanism 52 is also constructed similarly to the supporting mechanism 40 of the first embodiment except the followings. Four lower brackets of the second embodiment are attached to four corner portions of the rectangular frame 55 instead of the brackets 4 of the first embodiment being attached to the hull 1. In addition, although the second supporting mechanism 52 has fifth to eighth pairs of wheel and receiver assemblies 31A to 31D where the receivers of the second supporting mechanism 52 are each provided with a concave surface along which the wheel roll, guide directions of the concave surfaces of the receivers are aligned in a longitudinal direction of the hull 1 instead of guide directions of the receivers 5A to 5D of the first embodiment being aligned in the lateral direction. Therefore, the concave surfaces of the receivers of the second supporting mechanism 52 guide the wheels in the longitudinal direction to enable the cabin 2 to swing in a pitching motion direction.

The second supporting mechanism 52 is used for shifting right and left centers of oscillation of the cabin 2 in the longitudinal direction in left and right vertical planes III-III and IV-IV, respectively, when a load transfer occurs in the longitudinal direction, so as to keep the cabin 2 substantially horizontal when it is seen in a side view of FIG. 7, by suppressing an inclination change of the cabin 2 in spite of a pitching motion of the hull 1 in the side view.

The left center of oscillation is determined by using the fifth and seventh receivers 31A and 31C and their wheels rotatable thereon in the left side vertical plane III-III, and the right center of oscillation is determined by using the sixth and eighth receivers 31B and 31D and their wheels rotatable thereon in the right side vertical plane IV-IV. Note that these terms “right” and “left” are used with respect to the hull 1, not with respect to FIG. 7.

Consequently, the hull and the cabin 2 are swingable relative to each other around a first swing center line connecting the centers of the oscillation in the front and rear vertical planes I-I and II-II and also around a second swing center line connecting the centers of oscillation in the left and right vertical planes III-III and IV-IV.

As described above, the mounting device of the second embodiment can keep the flat floor of the cabin 2 substantially horizontal, thereby providing better ride comfort, when the load transfer to the cabin 2 occurs in the lateral direction and/or in the longitudinal direction and also when the hull 1 oscillates in the rolling motion direction and/or in the pitching motion direction in a state of the load transfer.

Incidentally, the first swing center line and the second swing line do not need to actually intersect with each other, as long as they can pass near their hypothetical intersection point so that the cabin 2 can move like the swinging motions described above. In addition, the rolling motion and the pitching motion of the cabin 2 have different characteristic values of their oscillations. For example, they are set so that a frequency of the rolling motion becomes lower than that of the pitching motion.

Next, a mounting device of a third embodiment according to the invention will be described with reference to the accompanying drawing.

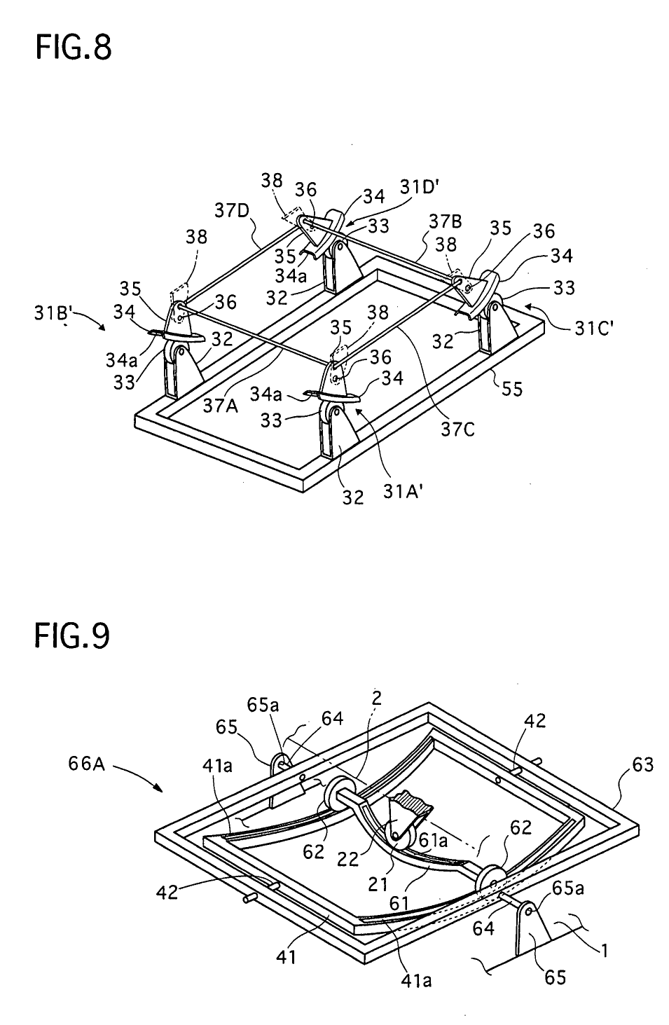

Referring to FIG. 8, there is shown the third preferred embodiment of the mounting device, which is also applied to a water vehicle. In the third embodiment, a hull and a cabin are also swingable relative to each other in both of a rolling motion direction and a pitching motion direction as well as the second embodiment.

The hull and the cabin are constructed similarly to those of the first and second embodiments, although the hull and the cabin are not illustrated in FIG. 8. A supporting mechanism 60 is disposed between the hull and the cabin, and has a first supporting mechanism, a second supporting mechanism and a rectangular frame 55 disposed therebetween.

The first supporting mechanism is, although not illustrated in FIG. 8, constructed similarly to that of the second embodiment so as to shift the front and rear centers of oscillation of the cabin in a lateral direction of the hull in front and rear vertical planes through the rectangular frame 55, suppressing an inclination of the cabin in a plane of a rolling motion thereof in spite of a rolling motion of the hull.

The second supporting mechanism has fifth to eighth pairs of wheel and receiver assemblies 31A′ to 31D′. The wheels 33 are supported by brackets 32 attached to four corner portions of the rectangular frame 55, and the receivers 34, each provided with a convex surface 34a along which the wheel 33 rolls, are attached to the cabin through brackets 38. The receivers 34 with the convex surfaces 34a are supported by the brackets 32 rotatably around shafts 36. Guide directions of the convex surfaces 34a and the wheels 33 are aligned in a longitudinal direction of the cabin. The convex surface 34a corresponds to the guide surface of the invention, and the receivers 34 correspond to the guide members of the invention.

The fifth pair of the assembly 31A′ and the sixth pair of the assembly 31B′ are connected with each other by a fifth rod 37A, the seventh receiver 31C′ and the eighth receiver 31D′ are connected with each other by a sixth rod 37B, the fifth receiver 31A′ and the seventh receiver 31C′ are connected with each other by a seventh rod 37C, and the sixth receiver 31B′ and the eighth receiver 31D′ are connected with each other by an eighth rod 37D. One of the rods 37A to 37D, for example the fifth rod 37A, is moved by a not-shown second operating lever constructed similarly to that of the first embodiment, although the lever of the third embodiment is operated in the longitudinal direction. The second operating lever acts as a part of a controller of the invention.

In this third embodiment, the front and rear centers of oscillation of the cabin can be shifted in a lateral direction of the hull in front and rear vertical planes, respectively, by the controller according to a load transfer in the lateral direction. This enables the cabin to be kept substantially horizontal in a front view through the rectangular frame 55. In addition, the left and right centers of oscillation of the cabin can be shifted in the longitudinal direction of the hull in left and right vertical planes.

Therefore, the mounting device of the third embodiment has advantages similar to those of the second embodiment.

Next, a mounting device of a fourth embodiment according to the invention will be described with reference to the accompanying drawings.

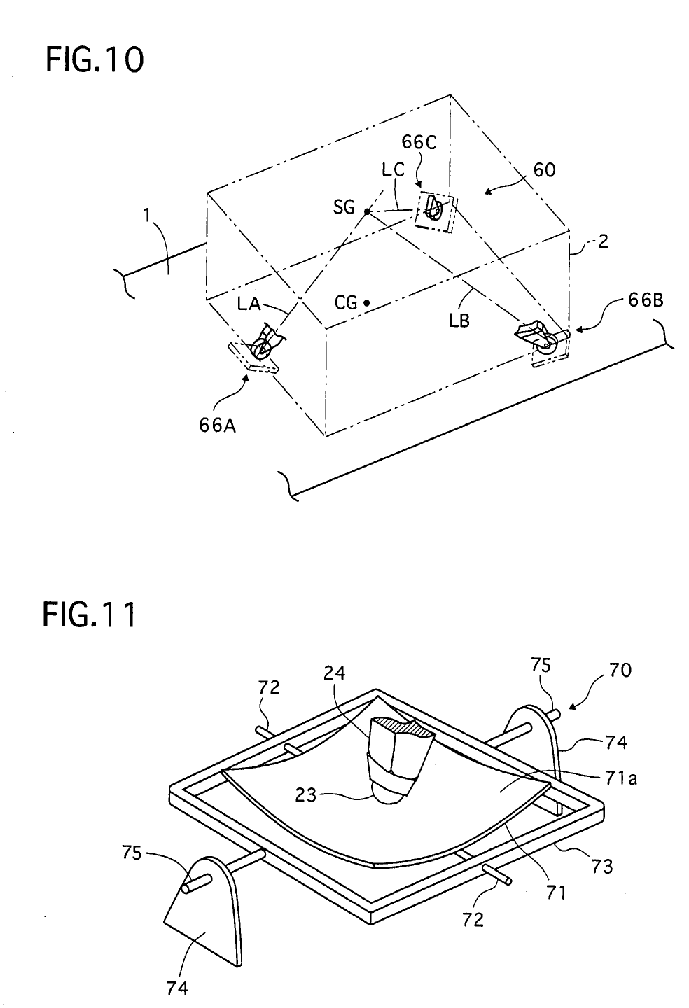

Referring to FIGS. 9 and 10, there is shown the mounting device of the fourth embodiment, which is applied to a water vehicle. In the fourth embodiment, a not-shown hull and a cabin 2 are also swingable relative to each other in both of a rolling motion direction and a pitching motion direction of the cabin 2. The cabin 2 is supported on the hull 1 by using a supporting mechanism 60 shown in FIG. 10 which is more schematically illustrated.

The supporting mechanism 60 has three pairs of wheel and receiver assemblies 66A to 66C at a center front portion, a left rear portion and a right rear portion of the cabin 2, respectively. The first to third pairs of the assemblies 66A to 66C are constructed similarly to one another, and basically have a gimbal structure as shown in FIG. 9.

FIG. 9 shows the first pair of the assembly 66A, where it includes a square frame 63, a first concave member 41, and a second concave member 61.

The square frame 63 is supported swingably in a first swinging motion direction (a pitching motion direction in the first pair of the assembly 66A) by brackets 65 with holes 65a in which pivots 64 of the frame 63 are inserted. The pivots 64 are controlled to turn by a not-shown controller for changing an inclination of the frame 63.

The first concave member 41 is supported on the frame 63, being swingably relative to the frame 63 at pivots 42 in a second swinging motion direction (a rolling motion direction in the first pair of the assembly 66A) perpendicular to the first swinging motion direction. The concave member 41 is provided at its both side portions with concave surfaces 41a along which wheels 62 roll. The wheels 62 are rotatably supported by the second concave member 61 which traverses the side portions of the first concave member 61, and they can move in a direction parallel to the pivots 42. The pivots 42 is controlled to turn by the controller for changing an inclination of the first concave member 41.

The second concave member 61 is provided with a concave surface 61a along which a wheel 21 rolls which is supported by a bracket 22 attached to the cabin 2. The concave surface 61a extends in a direction parallel to the pivots 64 of the frame 63.

Incidentally, the wheels 21 and 62 correspond to the rotating members of the invention, the second concave member 61 corresponds to the guide member of the invention, and the concave surfaces 41a and 61a correspond the guide members of the invention.

The second and third pairs of the assemblies 66B and 66C are constructed similarly to the first pair of the assembly 66A except their attachment directions are different from that of the first pair of the assembly 66A as shown in FIG. 10.

The inclinations of the frame 63 and the first concave member 41 of the first to third pairs of the assemblies 66A to 66C determine third perpendicular lines LA, LB and LC to form the center of oscillation SG of the cabin 2 at their intersection point being directly above the center of gravity OC of the cabin 2, where the first to third perpendicular lines LA to LC are perpendicular to the concave surfaces 61a at contact points of the concave surfaces 61a and wheels 21 of the first to third pairs of the assemblies 66A to 66C, respectively.

The inclinations thereof are controlled by the controller so that the center of oscillation can shift, according to a displacement of the center of gravity CG due to a load transfer to the cabin 2, in both of a rolling motion direction and a pitching motion direction by changing directions of the first to third perpendicular lines LA, LB and LC when a load transfer to the cabin 2 occurs so as to form a new center of oscillation. This new center of oscillation is set directly above a new center of gravity CG of the cabin 2 so that the cabin 2 is kept substantially horizontal. Accordingly, the hull and the cabin 2 are swingable relative to each other around the center of oscillation SG.

Therefore, the mounting device of the fourth embodiment has advantages similar to those of the second and third embodiment.

Note that, in actual, the first to third perpendicular lines LA to LC do not need to accurately intersect with one another as long as they can pass near their hypothetical intersection point so that the cabin can move like the swinging motions described above.

Next, a mounting device of a fifth embodiment according to the invention will be described with reference to the accompanying drawing.

Referring to FIG. 11, there is shown a pair of ball and receiver assembly of a supporting mechanism 70 used in the mounting device of the fifth embodiment, which is applied to a water vehicle. In the fifth embodiment, a not shown hull and a not-shown cabin are swingable relative to each other in any swinging motion direction.

The supporting mechanism 70 has three pairs of the assemblies, each pair including a square frame 73, a concave member 71 and a ball 23. The ball 23 corresponds to the rotating member of the invention, and the concave member 71 and the square frame 73 correspond to the guide member of the invention.

The frame 73 is supported by the brackets 74 attached to the hull swingably in a first swinging motion direction around two pivots 75 of the frame 73. The pivots 75 are controlled to turn by a not-shown controller.

The concave member 71 is supported by the frame 73 swingably in a second swinging motion direction, which is perpendicular to the first swinging motion direction, around the pivots 72 of the concave member 71. The concave member 71 has a concave surface 71a shaped in a partial sphere on which the ball 23 can roll. The ball 23 is rotatably held by a bracket 24 attached to the cabin. The concave member 71 corresponds to the guide surface of the invention, and the concave surface 71a corresponds to the guide surface of the invention.

The three pairs of the assemblies are arranged at a bottom portion of the cabin, like an arrangement shown in FIG. 10 of the fourth embodiment, so that their first to third perpendicular lines can intersect to form the center of oscillation of the cabin being directly above the center of gravity thereof. The controller is capable of turning the pivots 75 of the frame 73 and the pivots 72 of the concave member 71 to shift the center of oscillation in any direction according to a displacement of the center of gravity of the cabin due to a load transfer to the cabin. Therefore, the hull and the cabin are swingable relative to each other around the center of oscillation, being directly above the center of gravity of the cabin, is spite of swing motions of the hull.

The mounting device of the fifth embodiment has advantages in that the cabin can be kept substantially horizontal in any direction in spite of swinging motions of the hull and the load transfer of the cabin.

Next, a mounting device of a sixth embodiment according to the invention will be described with reference to the accompanying drawings.

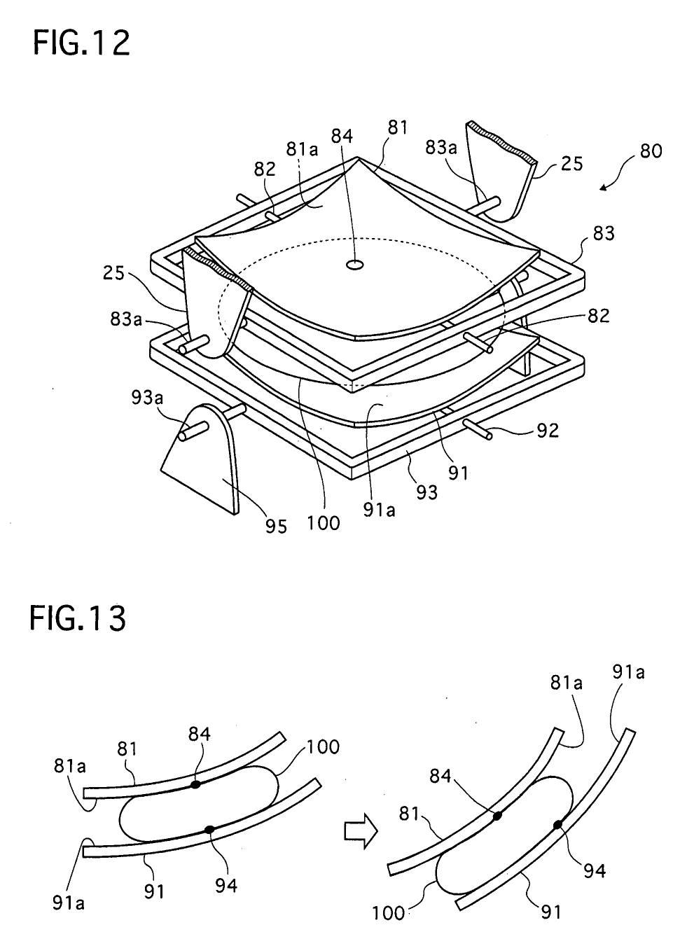

Referring to FIG. 12, there is shown a supporting mechanism 80 of the mounting device of the sixth embodiment, which is applied to a water vehicle. In the sixth embodiment, a not-shown hull and a not-shown cabin are swingable relative to each other in any swinging motion direction. The cabin is supported on the hull by using a supporting mechanism 80.

The supporting mechanism 80 has three pairs of bag and receiver assemblies arranged at a bottom portion of the cabin like an arrangement shown in FIG. 10 of the fourth embodiment, although one pair of the assembly is illustrated in FIG. 12. The first to third pairs of the assemblies are constructed similarly to one another.

The first pair of the assembly includes a first square frame 93, a concave member 91, a convex member 81, a second square frame 83 and a bag 100. The first square frame 93, the concave member 91, the convex member 81, and the second square frame 83 correspond to the guide member of the invention.

The first square frame 93 is supported by brackets 95 attached to the hull swingably around two pivots 93a of the first frame 93. The pivots 93a are controlled to turn in a first swinging direction by a not-shown controller. The concave member 91 is supported by the first frame 93 swingably around two pivots 92 of the concave member 91 with a concave surface 91a shaped like a partial sphere. The pivots 92 are controlled to turn in a second swinging direction perpendicular to the first swinging direction by the controller.

The second square frame 83 is supported by brackets 25 attached to the cabin swingably around two pivots 83a. The pivots 83a are controlled to turn in the first swinging direction by the controller. The convex member 81 is supported by the second frame 83 swingably around two pivots 82 of the convex member 81. The convex member 81 has a convex surface 81a shaped like a partial sphere. The pivots 82 are controlled to turn in the second swinging direction by the controller. The concave surface 91a and the convex surface 81a corresponds to the guide surfaces of the invention.

The bag 100 is disposed between the concave member 91 and the convex member 81, contacting with the concave surface 91a and the convex surface 81a. The bag 100 is connected the members 91 and 81 at their connecting positions 94, shown in FIG. 13, and 84, respectively. The bag 100 contains fluid, that is gas and liquid, the gas in this embodiment, and is deformable.

In the sixth embodiment, the bags 100 of the three sets of the assemblies support the cabin by applying their support forces in directions, which are determined by inclinations of the concave surface 91a and the convex surface 81a. The inclinations of the supporting forces, corresponding to an inclination of a perpendicular line, become high when the inclinations of the surfaces 91a and 81a are low as shown in a left half of FIG. 13, while they become low when the inclinations thereof are high as shown in a right half of FIG. 13. Note that the convex member 81 moves more downward relative to the concave member 91, the bag 100 being deformed, as their inclinations become higher.

The inclinations of the first to third pairs of the assemblies are controlled when a load transfer to the cabin occurs so that the center of oscillation of the cabin can shift in a direction according to that of a displacement of the center of gravity of the cabin, where three perpendicular lines from the pairs of the assemblies intersect to form a new center of oscillation being directly above a new center of the gravity. Therefore, the hull and the cabin are swingable relative to each other around the center of oscillation to keep the cabin substantially horizontal in spite of swinging motions of the hull.

The mounting device of the sixth embodiment has advantages similar to those of the fifth embodiment.

Note that the center of oscillation may be hypothetical as long as extension lines of the supporting forces pass near their hypothetical intersection point so that the cabin can move like the swing motions described above.

While there have been particularly shown and described with reference to preferred embodiments thereof, it will be understood that various modifications may be made therein, and it is intended, to cover in the appended claims all such modifications as fall within the true spirit and scope of the invention.

Although the mounting devices of the embodiments described above are applied to the water vehicles, they can be applied to devices other than the water vehicles. Therefore, the movable body is not limited to the cabin, and the base is not limited to the hull. The mounting device can be applied any device where the movable body is supported on the base swingably and the base swings.

In the first to sixth embodiments, the flat floor 2a of the cabin 2 is kept horizontal, while the movable body of the invention does not need to have a flat floor and does not need to be kept horizontal. In the invention, the supporting device may be constructed to shift the center of oscillation so that a change in an inclination of the movable body due to a load transfer to the movable body can be decreased, not necessarily the case that the movable body. Its proper inclination depends on its mounting conditions

The number and locations of the receivers, wheels, balls and bags may be set appropriately according to use conditions and others.

What is claimed is:

1. A mounting device comprising:
a base;
a movable body for mounting at least one of a passenger and a cargo;
a supporting mechanism disposed between the base and the movable body for applying supporting forces to the movable body from a plurality of positions of the base to support the movable body on the base and determining a center of oscillation of the movable body so that the movable body can swing relative to the base due to gravity acting on the movable body with respect the center of oscillation which is set higher than a center of gravity of the movable body; and
a controller for controlling the supporting mechanism which is capable of shifting the center of oscillation, by changing directions support forces acting on the movable body, at least in a horizontal direction according to a change of the center of the oscillation so that a change in an inclination of the movable body due to a load transfer to the movable body can be decreased.

2. The mounting device according to claim 1, wherein
the directions of the supporting forces determines one of the center of oscillation and a swing center line connecting with two centers of oscillation around which the movable body is capable of swung.

3. The mounting device according to claim 1, wherein
the supporting mechanism has a plurality of rotating members and a plurality of guide members with a guide surface along which each of the rotating member can roll, the rotating members being rotatably supported by one of the base and the movable body, and the guide members being attached to the other of the base and the movable body, wherein
perpendicular lines, which are perpendicular to the guide surfaces of the guide members at contact points of the rotating members and the guide surfaces respectively, intersect to form the center of the oscillation of the movable body, and when
the controller is capable of changing inclinations of the guide surfaces of the guide members.

4. The mounting device according to claim 3, wherein
the guide members are mechanically connected with each other so that the guide surfaces of the guide members can be turned towards the same directions thereof in a swinging motion of the movable body.

5. The mounting device according to claim 3, wherein
the rotatable members are one of wheels and balls, and wherein
the guide surfaces of the guide members are formed in one of a concave shape and a convex shape.

6. The mounting device according to claim 5, wherein
the concave surface and the convex surface are formed to be partially spherical.

7. The mounting device according to claim 1, wherein
the supporting mechanism has an intermediate supporting member disposed between the base and the movable body, a first supporting mechanism disposed between the base and the intermediate supporting member for supporting the intermediate supporting member and determining a first center of oscillation of the movable body by changing a first directional inclination of the intermediate supporting member, and a second supporting mechanism disposed between the intermediate supporting member and the movable body for supporting the movable body and determining a second center of oscillation of the movable body by changing a second inclination of the intermediate supporting member.

8. The mounting device according to claim 7, wherein
the first support mechanism and the second mechanism have a plurality of rotating members and a plurality of guide members with a guide surface along which each of the rotating member can roll, the rotating members being rotatably supported by one of the base and the movable body, and the guide members being attached to the other of the base and the movable body, wherein
perpendicular lines, which are perpendicular to the guide surfaces of the guide members at contact points of the rotating members and the guide surfaces respectively, intersect to form the center of the oscillation of the movable body, and when
the controller is capable of changing inclinations of the guide surfaces of the guide members.

9. The mounting device according to claim 8, wherein
the guide members are mechanically connected with each other so that the guide surfaces of the guide members can be turned towards the same directions thereof in a swinging motion of the movable body.

10. The mounting device according to claim 8, wherein
the rotatable members are one of wheels and balls, and wherein
the guide surfaces of the guide members are formed in one of a concave shape and a convex shape.

11. The mounting device according to claim 10, wherein
the concave surface and the convex surface are formed to be partially spherical.

12. The mounting device according to claim 7, wherein
the intermediate supporting member is a quadrangular frame.

13. The mounting device according to claim 1, wherein
the supporting mechanism has a plurality of bags and a plurality of guide members with a pair of guide surfaces sandwiching and connecting the bag, the bag containing fluid to be deformable between the guide surfaces for applying the supplying forces, wherein
the guide members with one of the pair of guide surfaces are attached to one of the base and the movable body, and the guide members with the other of the pair of guide surfaces are attached to the other of the base and the movable body, wherein
perpendicular lines, which are perpendicular to the guide surfaces of the guide members at contact points of the bags and the guide surfaces respectively, intersect to form the center of the oscillation of the movable body, and when
the controller is capable of changing inclinations of the guide surfaces of the guide members.

14. The mounting device according to claim 13, wherein
the guide surfaces of the guide members are formed to have a pair of concave and convex surfaces, where the concave surface is provided at one of base side guide members and movable-body side guide members and the convex surface is provide at the other of the base side guide members and the movable-body side guide members.

15. The mounting device according to claim 14, wherein
the concave surface and the convex surface are formed to be partially spherical.

16. The mounting device according to claim 1, wherein
the base is a hull of a water vehicle and the movable body is a cabin thereof.
